(19) United States
(12) Patent Application Publication
(10) Pub. No.: US 2015/0288195 A1
(43) Pub. Date: Oct. 8, 2015

(54) ADAPTABLE INDUCTIVE POWER RECEIVER FOR ELECTRICAL DEVICES

(71) Applicants: Rotem SHRAGA, Kiryat Ono (IL); Yoel RAAB, (US); Oola GREENWALD, Mevasseret Zion (IL); Moti ASHERY, Mevaseret Zion (IL); Moti KDOSHIM, Modiin (IL); Ilya GLUZMAN, Holon (IL); Powermat Technologies, Ltd., Neve Ilan (IL)

(72) Inventors: Moti Ashery, Mevaseret Zion (IL); Moti Kdoshim, Modiin (IL); Ilya Gluzman, Holon (IL)

(21) Appl. No.: 14/441,482

(22) PCT Filed: Nov. 7, 2013
(86) PCT No.: PCT/IL2013/050917

§ 371 Date: May 7, 2015

Related U.S. Application Data
(60) Provisional application No. 61/726,911, filed on Nov. 15, 2012.
(60) Provisional application No. 61/723,333, filed on Nov. 7, 2012.

(51) Int. Cl. H02J 5/00; H01F 38/14; H02J 7/02

(52) U.S. Cl. CPC H02J 5/005; H02J 7/025; H01F 38/14

(57) ABSTRACT

A universal inductive power receiver is adaptable such that it may be retrofitted to various host electrical devices so as to render them compatible with wireless power providing systems. The power receiver includes a power receiving circuit for controlling current output for various electrical devices and a receiver unit affixable to the electric device in a plurality of configurations such that a device connector may be conveniently positioned to couple with variously positioned and oriented power sockets of a plurality of possible host electrical devices.

### FIELD OF THE DISCLOSURE

The disclosure herein relates to wireless power transfer. In particular the disclosure relates to inductive power receivers for providing power to electrical devices.

### BACKGROUND

Inductive power coupling, as known in the art, allows energy to be transferred from a power supply to an electric load without connecting wires. A power supply is wired to a primary coil and an oscillating electric potential is applied across the primary coil, thereby inducing an oscillating magnetic field. The oscillating magnetic field may induce an oscillating electrical current in a secondary coil placed close to the primary coil. In this way, electrical energy may be transmitted from the primary coil to the secondary coil by electromagnetic induction without the two coils being conductively connected. When electrical energy is transferred from a primary coil to a secondary coil the coil pair are said to be inductively coupled. An electric load wired in series with such a secondary coil may draw energy from the power source wired to the primary coil when the secondary coil is inductively coupled thereto.

Induction type power outlets may be preferred to the more common conductive power sockets because they provide seamless power transmission and minimize the need for trailing wires.

### SUMMARY

There is a need for an adaptable inductive power receiver which is compatible for use with a variety for electrical devices. The present disclosure addresses this need.

One aspect of the disclosure is to introduce a universal inductive power receiver for receiving power inductively from an inductive power outlet and providing an current output to an electric device. The inductive power receiver may comprise a secondary inductor operable to inductively couple with a primary inductor of an inductive power outlet, and a power receiving circuit for controlling power relayed to the electric device. The power receiving circuit comprises: a triggerable current limiter operable to maintain the current output within an operating range; and a trigger operable to activate the triggerable current limiter if the current output exceeds a trigger current reference. Optionally, the triggerable current limiter comprises a high side power-distribution switch.

Another aspect of the disclosure is to teach a method for controlling output current from a universal wireless power receiver. The method may comprise: providing a triggerable current limiter; determining a trigger current reference; comparing the current output to the trigger current reference; if the current output exceeds the trigger current value then activating the current limiter; and when activated, the current limiter maintaining the current output within an operating range. Variously, the trigger current value is about one ampere. The operating range is characterized by an upper current limit value such as a value of 750 milli-amperes or the like.

Still another aspect of the current disclosure is to present an inductive power receiver for receiving power inductively from an inductive power outlet and relaying power to an electric device. The inductive power receiver may comprise: a receiver unit comprising a secondary inductor operable to inductively couple with a primary inductor of an inductive power outlet, and a power receiving circuit for controlling power relayed to the electric device; and a connector for conductively coupling the inductive receiving circuit to the electric device via a power socket. The inductive power receiver may be affixable to the electric device in a plurality of configurations such that the position of the connector is adaptable to suit a plurality of power socket locations.

Variously, the connector may be configured to extend from the receiving unit with a plurality of extensions. Additionally or alternatively, the connector may comprise a stretchable flex. Such a stretchable flex may comprise at least two conductive lines embedded in an elastic material.

The stretchable flex may comprise at least two conductive lines having an extendable configuration such that when the stretchable flex is extended the conductive lines remain unbroken. Accordingly, the extendable configuration may be selected from at least one of a group consisting of: coiled configurations, zig-zag configurations, helical configurations, telescopic configurations or combinations thereof. Optionally, the connector comprises a flex silicon cable.

Where appropriate, the connector may be selected from a set of cables having a plurality of lengths. Alternatively, or additionally, the connector may comprise a slider and/or the connector may comprise a cord extractable from the receiver unit.

In some embodiments, the connector comprises a conductive coupler for connecting the connector to the receiver unit. Optionally, the connector is configured to selectably connect to the receiver unit at at least one of a plurality of connection points.

Accordingly, the connector may be configured to connect the receiver unit to the electric device over a plurality of distances.

Where required, the receiver unit may comprise at least one conducting track and the connector comprises at least one conducting tip configured to selectably conductively couple with the conducting track at a plurality of points. Optionally, the receiver unit comprises an anode track and a cathode track and the connector comprises: an anode tip configured to conductively couple with the anode track, and a cathode tip configured to conductively couple with the cathode track.

Optionally, the receiver unit comprises an upper cover and a lower cover configured to snap connect thereby securing the connector therebetween in conductive communication with the receiver circuit.

In certain embodiments, the connector comprises a plug tip configured to couple with the power socket with the power socket of the electric device. The plug tip may be adaptable to fit a plurality of configurations of the power socket. Variously, the plug tip may be selected from a group consisting of: USB connectors, micro USB connectors, mini USB connectors, multipin DC connectors, dock connectors, 30-pin connectors, 8-pin digital connectors, Apple Lightning connectors and combinations thereof. Where required, the power receiver may comprise an adhesive layer for affixing the receiver unit to the electrical device.

It is noted that in order to implement the methods or systems of the disclosure, various tasks may be performed or completed manually, automatically, or combinations thereof. Moreover, according to selected instrumentation and equipment of particular embodiments of the methods or systems of the disclosure, some tasks may be implemented by hardware, software, firmware or combinations thereof using an operating system. For example, hardware may be implemented as a chip or a circuit such as an ASIC, integrated circuit or the like. As software, selected tasks according to embodiments of the disclosure may be implemented as a plurality of software instructions being executed by a computing device using any suitable operating system.

In various embodiments of the disclosure, one or more tasks as described herein may be performed by a data processor, such as a computing platform or distributed computing system for executing a plurality of instructions. Optionally, the data processor includes or accesses a volatile memory for storing instructions, data or the like. Additionally or alternatively, the data processor may access a non-volatile storage, for example, a magnetic hard-disk, flash-drive, removable media or the like, for storing instructions and/or data. Optionally, a network connection may additionally or alternatively be provided. User interface devices may be provided such as visual displays, audio output devices, tactile outputs and the like. Furthermore, as required user input devices may be provided such as keyboards, cameras, microphones, accelerometers, motion detectors or pointing devices such as mice, roller balls, touch pads, touch sensitive screens or the like.

### BRIEF DESCRIPTION OF THE FIGURES

For a better understanding of the embodiments and to show how it may be carried into effect, reference will now be made, purely by way of example, to the accompanying drawings.

With specific reference now to the drawings in detail, it is stressed that the particulars shown are by way of example and for purposes of illustrative discussion of selected embodiments only, and are presented in the cause of providing what is believed to be the most useful and readily understood description of the principles and conceptual aspects. In this regard, no attempt is made to show structural details in more detail than is necessary for a fundamental understanding; the description taken with the drawings making apparent to those skilled in the art how the several selected embodiments may be put into practice. In the accompanying drawings:

FIG. 1a is a schematic diagram representing an inductive power receiver of the disclosure connected to an electrical device;

FIG. 1b is a schematic diagram representing an inductive power transfer system of the disclosure being used to charge an electrical device using an inductive power receiver of claim 1a;

FIG. 1c is a block diagram representation of the main components of an inductive power transfer system including an inductive power receiver of the disclosure;

FIGS. 2a-d is a schematic diagram representing how a universal inductive power receiver of the disclosure may be configured to connect to various electrical devices having various dimensions;

FIGS. 3a and 3b are schematic diagram of a particular embodiment of a universal inductive power receiver of the disclosure;

FIGS. 3c-e are schematic diagram of another embodiment of a universal inductive power receiver of the disclosure having a stretchable flex;

FIGS. 4a and b schematically represent how a connector may be extended from a receiving unit of a particular embodiment of the universal inductive power receiver;

FIGS. 5a-e show various aspects of another embodiment of a universal inductive power receiver of the disclosure;

FIG. 5f shows a connector retraction apparatus for use in retracting and stowing a connector for example within the receiver unit;

FIGS. 6a-d show a selection of possible embodiments of universal inductive power receivers which having an extendable connector;

FIG. 6e-g show an adjustable connector adaptable to suit a variety of configurations to suit various devices;

FIGS. 7a-c shows an embodiment of a universal inductive power receiver in which various connectors may be connected to the receiver unit at a connection point;

FIGS. 8a-c shows an another embodiment of another universal inductive power receiver in which various connectors may be connected to the receiver unit at a multi-pin connection point;

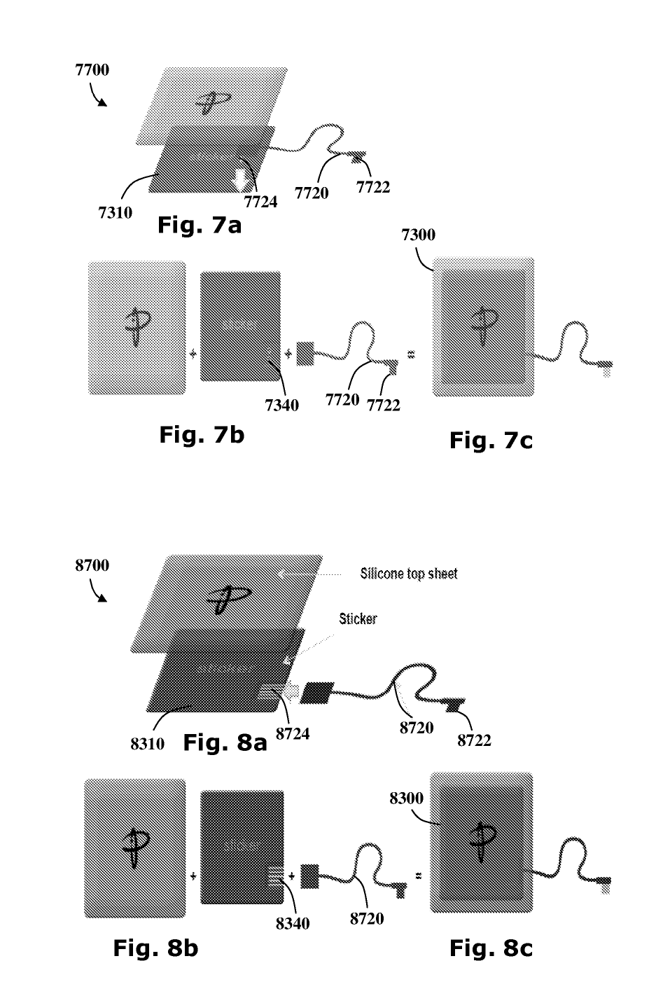

FIGS. 7a-c shows an embodiment of a universal inductive power receiver in which various connectors may be connected to the receiver unit at any connection point along a pair of conducting tracks:

FIG. 10a is a block diagram representing the main components of an automatic current-limit reduction unit;

FIG. 10b is a block diagram representing pin layout design of a possible standard current limiting unit such as NCP380L that may provide basic functionality for the current disclosure;

FIG. 10c is a block diagram of a possible circuitry design representation of an automatic current-limit reduction embodiment;

FIG. 10d is a graphical illustration of a possible display output of an automatic current-limit reduction unit; and

FIG. 11 is a flowchart representing selected actions of a method for controlling output current from a universal wireless power receiver of the disclosure.

### DETAILED DESCRIPTION

Aspects of the present disclosure relate to wireless charging or powering systems, including a universal inductive power receiver which is adaptable such that it may be retrofitted to various electrical devices so as to render them compatible with wireless power providing systems.

Optionally, the power receiver includes a receiver unit affixable to the electric device in a plurality of configurations such that a device connector may be conveniently positioned to couple with variously positioned and oriented power sockets of a plurality of possible host electrical devices.

It is noted that the systems and methods of the disclosure herein may not be limited in its application to the details of construction and the arrangement of the components or methods set forth in the description or illustrated in the drawings and examples. The systems and methods of the disclosure may be capable of other embodiments or of being practiced or carried out in various ways.

Alternative methods and materials similar or equivalent to those described herein may be used in the practice or testing of embodiments of the disclosure. Nevertheless, particular methods and materials are described herein for illustrative purposes only. The materials, methods, and examples are not intended to be necessarily limiting.

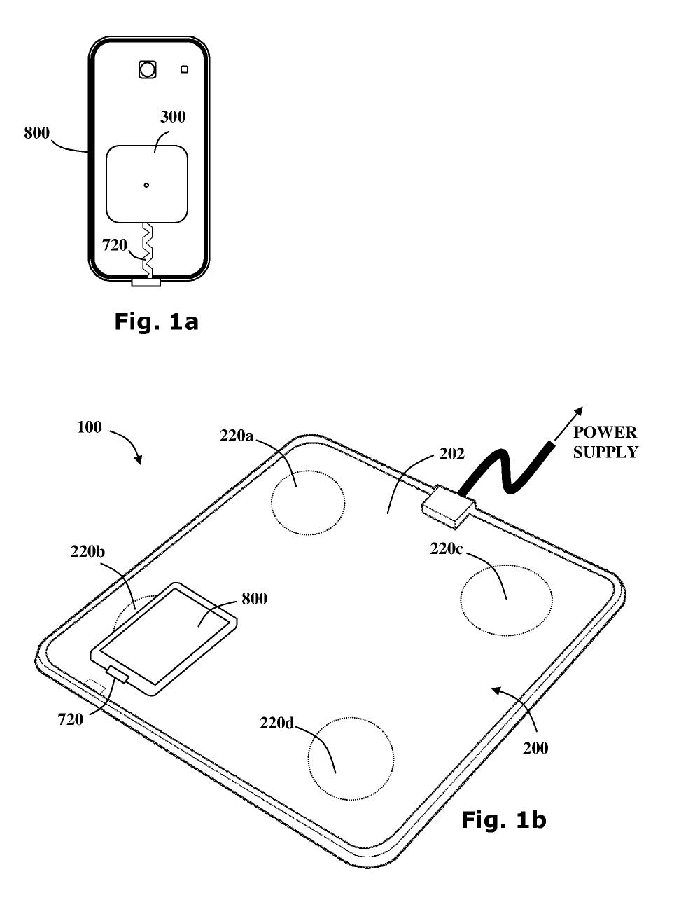

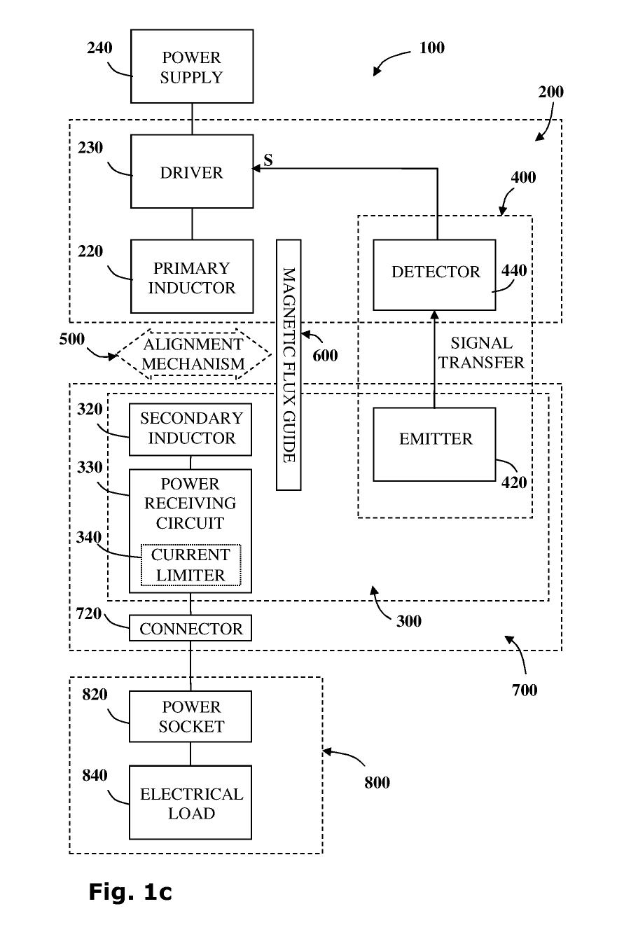

Reference is now made to FIGS. 1a and 1b showing an inductive power transfer system 100 comprising an inductive power outlet 200 and an inductive power receiver 700 according to the current disclosure. The inductive power transfer system 100 may be used to provide power wirelessly from a power supply to an electrical device.

It is noted that many electrical devices, such as a mobile communication devices 800 or the like, are powered by internal power packs. Accordingly, the inductive power receiver 700 may be utilized to relay power to the electrical device for example to charge the internal power pack wirelessly. Alternatively or additionally, where appropriate, the system 100 may be used to power electrical devices directly.

Referring particularly to FIG. 1a, the inductive power receiver 700 may include a receiver unit 300 and a connector 720. The receiver unit 300 may incorporate a power receiving circuit for receiving power from the inductive power outlet and the connector 720 may be used to connect the inductive receiving circuit to the electric device via a power socket. It is a particular feature of the disclosure that the inductive power receiver 700 may be affixable to the electric device 800 in a plurality of configurations such that the position of the connector 720 may be conveniently positioned to couple with a power socket of the electrical device 800.

As shown in FIG. 1a, the inductive power outlet 200 may include primary inductors 220a-d incorporated within a platform 202. Electrical devices 800 with inductive power receiver 700 affixed thereto may be placed upon the platform 202 in alignment with a primary inductor 220b so that a secondary inductor of the inductive receiving circuit may inductively couples with the primary inductor 220b.

Referring now to the block diagram of FIG. 1c, selected components are presented of the inductive transfer system 100 for providing power from a power supply 240 to an electrical device 800. The system 100 includes an inductive power outlet 200, an inductive power receiver 700.

The inductive power outlet 200 includes a primary inductor 220, wired to the power supply 240 via a driver 230. The driver 230 typically includes electronic components, such as a switching unit for example, for providing an oscillating electrical potential to the primary inductor 220. The oscillating electrical potential across the primary inductor 220 produces an oscillating magnetic field in its vicinity.

The inductive power receiver 700 includes a receiver unit 300 and a connector 720. The receiver unit 300 includes a secondary inductor 320, a power receiving circuit 330 and optionally a current limiter 340. The secondary inductor 320 is configured such that, when placed in the oscillating magnetic field of an active primary inductor 220, a secondary voltage is induced across the secondary inductor 320.

The connector 720 may provide a conductive communication line for coupling the power receiving circuit 330 to the electric device 800.

Accordingly, the secondary voltage induced in the secondary inductor 320 may be used to power an electric load 840 of an electrical device 800. For example, secondary voltage may be used to charge an electrochemical cell, supercapacitor or other power storage unit of the electrical device 800. It is noted that an induced secondary voltage across the secondary inductor 320 produces an alternating current (AC).

It is a feature of the universal inductive power receiver 700 of the disclosure that it may be compatible with various electrical devices. It may be desirable that the characteristics of the output power be adaptable to suit requirements of various electrical devices. Accordingly, where the electric load 340 requires direct current (DC), such as for charging electrochemical cells, the power receiving circuit 330 may incorporate a rectification unit for converting AC to DC. Furthermore, the current limiter 340 may be provided to limit output current where required, as described hereinbelow.

Further elements may be additionally incorporated for improving the efficiency of power transfer from the inductive power outlet 200 to the inductive power receiver 300. For example, a signal transfer system 400, an alignment mechanism 500 and a magnetic flux guide 600, may be provided as required.

The signal transfer system 400 provides a channel for passing signals between the inductive power receiver 300 and the inductive power outlet 200. The signal transfer system 400 includes a signal emitter 420, associated with the inductive power receiver 300 and a signal detector 440, associated with the inductive power outlet 200. Signals may perform a variety of functions such as inter alia, confirming the presence of a power receiver 300, regulating power transfer, communicating required power transmission parameters, providing power transmission instructions or other data communication. For example, the signal transfer system 400 may be particularly useful in systems adapted to work at multiple power levels. Various signal transfer systems may be used such as optical, inductive, ultrasonic signal emitters or the like in combination with appropriate detectors. Some signal transfer systems 400 use coil-to-coil communication using transmission circuits and receptions circuits wired to the secondary inductor and primary inductor respectively. Examples of such are described in the applicants co-pending patents and patent applications including U.S. Pat. No. 8,188,619 as well as U.S. applications Ser. Nos. 12/524,987, 13/205,672 and 13/458,164 which are all incorporated herein by reference.

The alignment mechanism 500 may be provided to facilitate the alignment of the secondary inductor 320 with the primary inductor 220 thereby improving the efficiency of the inductive transfer system 100. Where the user is able to see the primary inductor 220 directly, the secondary inductor 320 may be aligned by direct visual observation. However, where the primary inductor 220 is concealed behind an opaque surface, alternative alignment mechanisms 500 may be necessary. Such alignment mechanisms 500 may include tactile, visual and/or audible indications, for example.

The magnetic flux guide 600 may be provided to guide magnetic flux from the primary inductor 220 to the secondary inductor 320 and to prevent flux leakage out of the inductive power transfer system 100, particularly into metallic or other conductive materials in the vicinity.

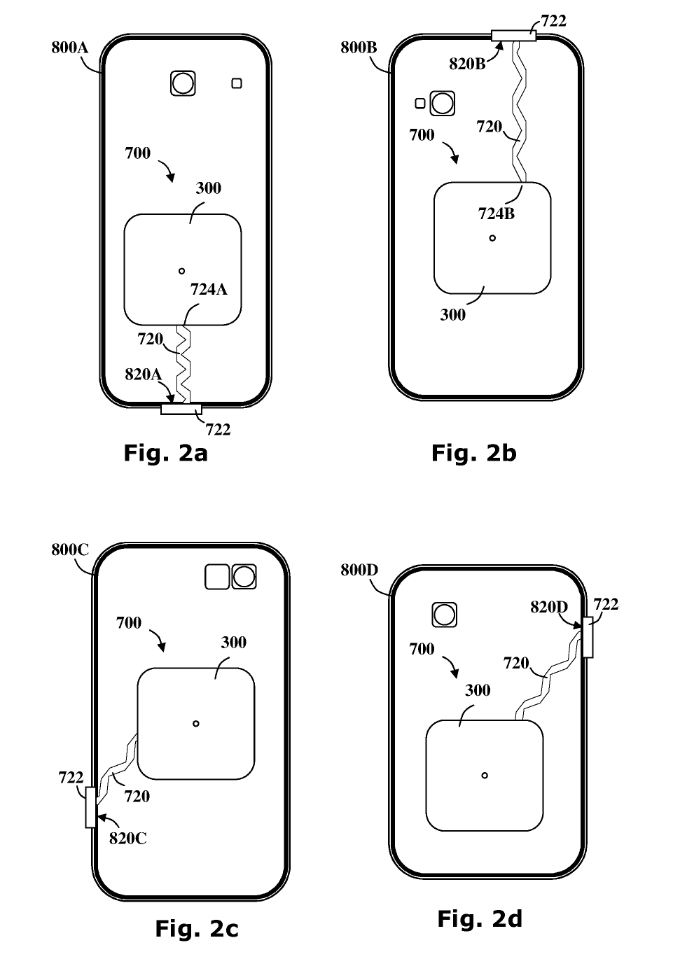

It is noted that a universal inductive power receiver 700 may be used to provide power to a variety of different electrical devices. It will be appreciated that the physical dimensions and configurations of different electrical devices generally vary from device to device. It is a particular feature of the current disclosure that the universal inductive power receiver 700 may be adaptable to fit a variety of host devices. Reference is now made to FIGS. 2a-d schematically representing how a universal inductive power receiver 700 of the disclosure may be configured to connect to various electrical devices 800A-D having various dimensions.

With particular reference to FIG. 2A a first electrical device 800A, such as a mobile phone, tablet, computer or the like, is shown being powered by a universal power receiver 700. The universal power receiver 700 includes a receiver unit 300 affixed to the host electrical device 800A, for example by an adhesive layer, and connector 720 having a connecting plug 720 configured to couple with a power socket 820A situated at the bottom edge of the host device 800A.

It is noted that various electrical devices 800 may have a variety of power sockets 820, accordingly, the power plug 722 may comprise a plug tip suitable to mate with at least one of: USB connectors, micro USB connectors, mini USB connectors, multipin DC connectors, dock connectors, 30-pin connectors, 8-pin digital connectors, Apple Lightning connectors or the like as well as combinations thereof.

Referring now to FIG. 2B, the same universal power receiver 700 is shown in a second configuration to adapt to a second electrical device 800B. The second electrical device 800B has significantly different dimensions, in particular the power socket 820B of the second electrical device 800B is situated on the upper edge. It is noted that the connector 720 of the universal power receiver 700 is extendable to cover a greater distance to the power socket 820B of the second device than was necessary for attachment to the power socket 820A of the first device 800A. It is further noted that the attachment point 724B of the connector 720 with the receiver unit 300 in the second configuration may be different from the attachment point 724A of the connector 720 with the receiver unit 300 in the first configuration. The adaptability of attachment point and extension may enable a common universal power receiver 700 to be adapted to a variety of electrical devices.

In order to better illustrate the adaptability of the universal power receiver, FIG. 2C shows the same universal power receiver 700 in a third configuration adapted to a third electrical device 800C via a power socket 820C upon the left edge. FIG. 2D shows the same universal power receiver 700 in still a fourth configuration adapted to a fourth electrical device 800D via a power socket 820D upon its right edge.

Thus the connector 720 may be configured to connect the receiver unit 300 to the electric device 800 over a plurality of distances and in a plurality of configurations.

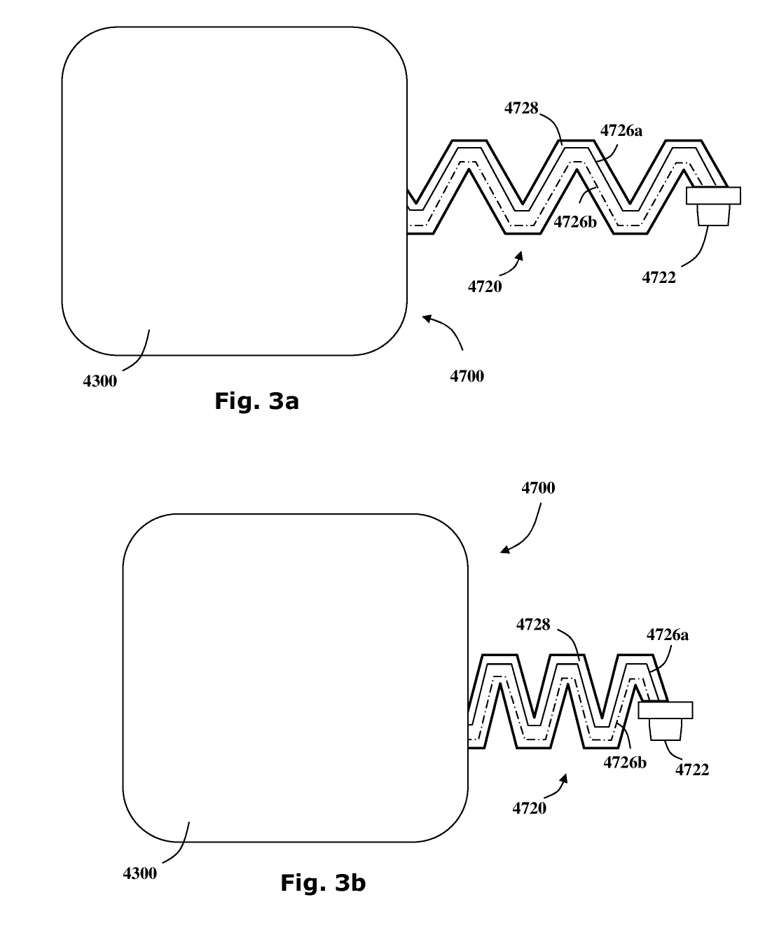

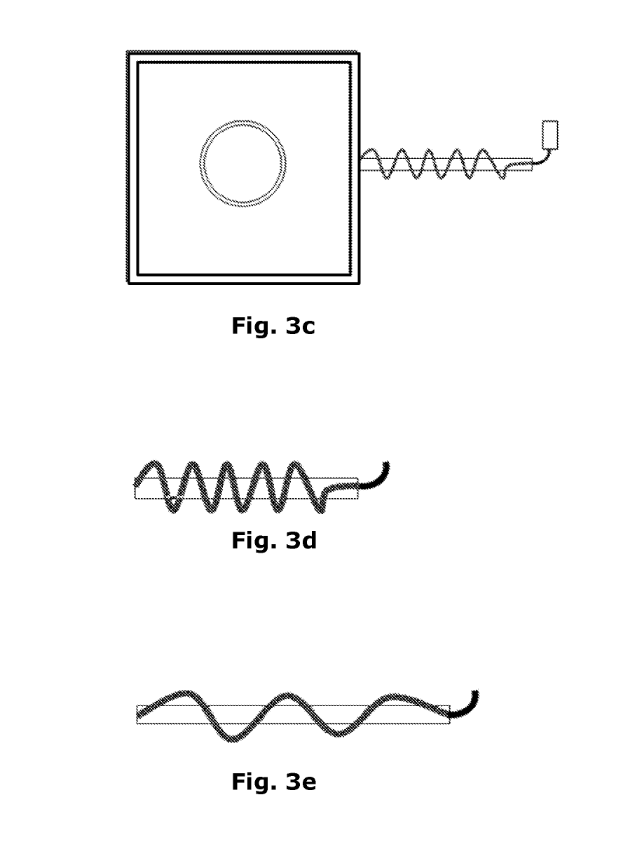

Reference is now made to FIGS. 3a and b which schematically represent an inductive power receiver 4700 having a receiver unit 4300 and an extendable connector 4720. The extendable connector 4720 may be extended from the receiving unit 4300 with a plurality of extensions.

The connector 4720 may comprise a connecting pin 4722, such as a USB connector, a micro USB connector, a mini USB connectors, a multipin DC connector, a dock connector, a 30-pin connector, an 8-pin digital connector, an Apple Lightning connector or the like, at the end of a stretchable flex. The flex may incorporate at least two conductive lines 4726a, 4726b embedded in an elastic material 4728 such as a flex silicon cable for example. The conductive lines 4726a, 4726b are configured such that even when extended, as illustrated in FIG. 3b, the conductive lines remain unbroken. Accordingly the flex may have a zig-zag configuration or the like such that the embedded wires are not themselves extended when the connector is reconfigured.

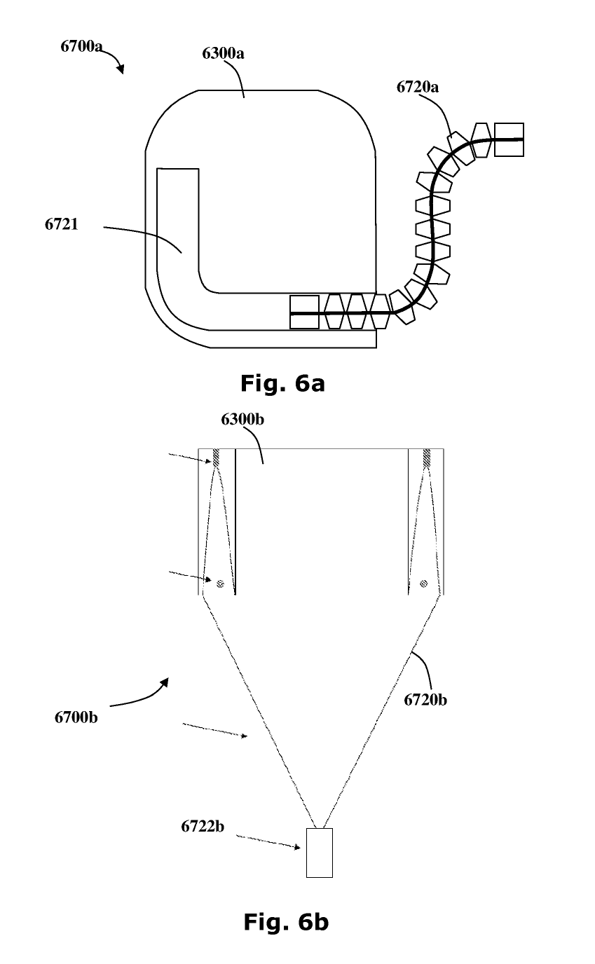

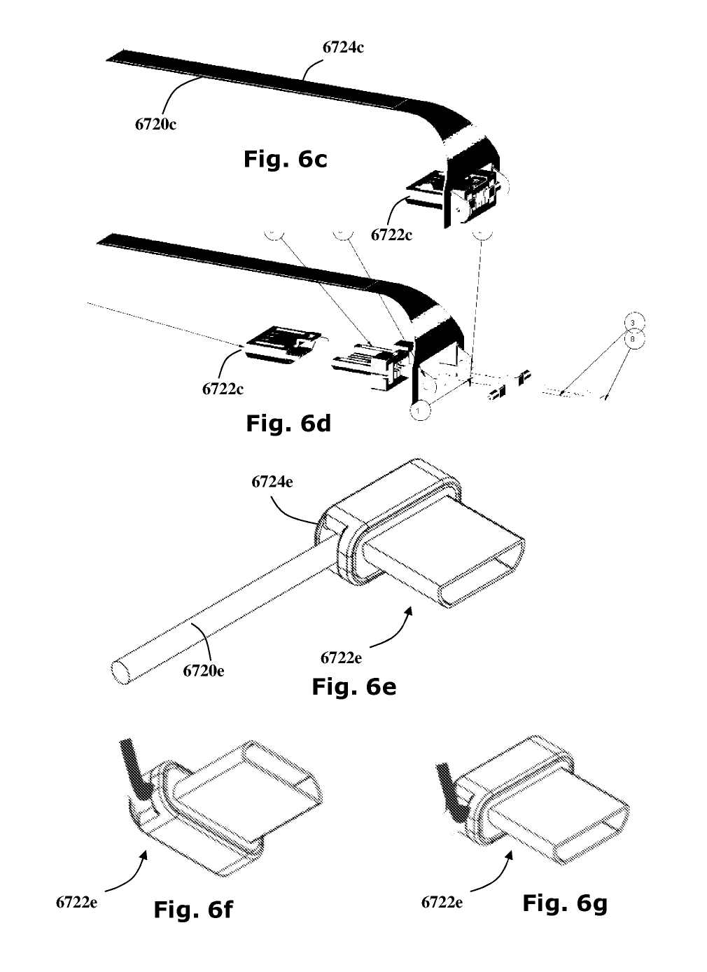

Still another embodiment of the extendable connector 4720′ is shown in FIGS. 3c-e. The connector 4720′ may comprise a connecting pin 4722′, such as a USB connector or the like, at the end of a stretchable flex 4720′ which comprises a multicore wire cable 4726′ and a rubber over mold 4726′. It will be appreciated that such a flex 4720′ may be stretched to various lengths to suit requirements. FIG. 3d shows a stretchable flex 4720′ having a short configuration. FIG. 3e shows the same stretchable flex 4720′ extended into a longer configuration. Such a connector may be combined, for example with an adjustable plug, such as shown in FIG. 6e hereinbelow or the like, to provide a configurable connector which may be conveniently retrofitted to a variety of devices.

Alternatively or additionally, other extendable configurations may be used such as coiled configurations, helical configurations, telescopic configurations or the like combinations thereof. Still other extendable configurations will occur to those skilled in the art.

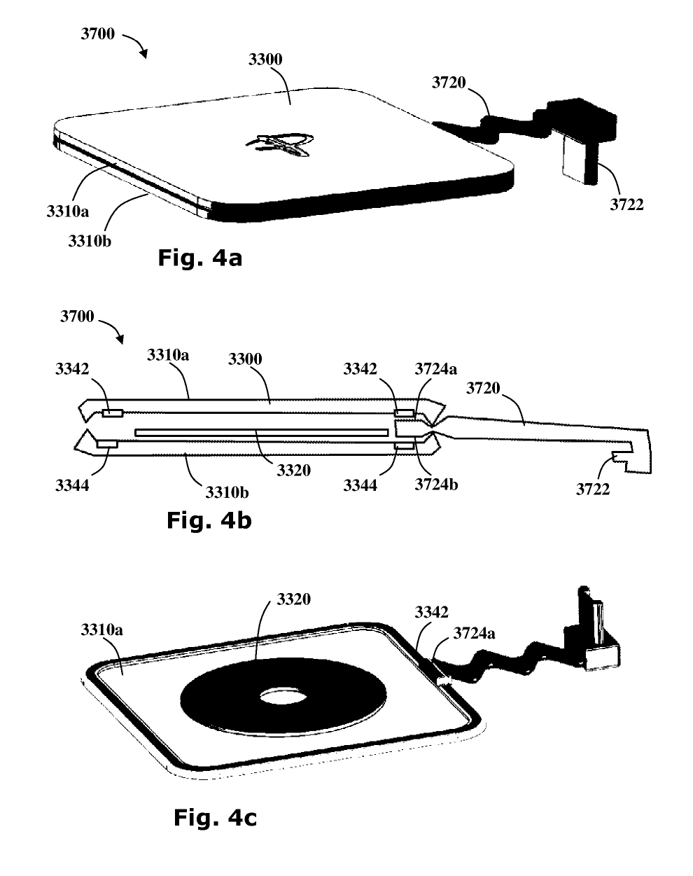

Reference is now made to FIGS. 4a and 4b schematically representing another embodiment of a universal inductive power receiver 3700, in isometric projection and cross section respectively, according to the current disclosure. The embodiment of the universal inductive power receiver 3700 includes a receiver unit 3300 and a connector 3720 terminating in a pin connector 3722 such as a micro USB connector or the like. It is noted that where the pin connector 3722 is not of symmetric configuration, the connector may adaptable such that the pin connector 3722 is alignable variously so as to connect with power sockets in a plurality of configurations on the host electrical device.

As illustrated in the cross section of FIG. 4b, the receiving unit 3300 of the embodiment, comprises a secondary inductor 3320 and receiving circuit (not shown) enclosed within a casing comprising an upper cover 3310a and a lower cover 3310b.

For illustrative purposes, FIG. 4c represents an isometric projection of the inside surface of the upper cover 3310a. The upper cover 3310a may further include a first conductive track 3342 provided to conductively couple with a first contact 3724a of the connector 3720. Similarly, the lower cover 3310b may further include a second conductive track 3344 provided to conductively couple with a second contact 3724b of the connector 3720. Accordingly anode and cathode terminals may be conductive connected to the connecting pin such that power may be provided to a host electrical device. It is noted that because the first conductive track 3342 and second conductive track 3344 extend around the whole perimeter of the receiving unit 3300, the connector 3720 may be connected at any point around the receiving unit 3300. Optionally the upper cover 3310a and the lower cover 3310b are configured to snap connect around connector 3720 thereby securing the connector into place once it has been positioned to suit requirements.

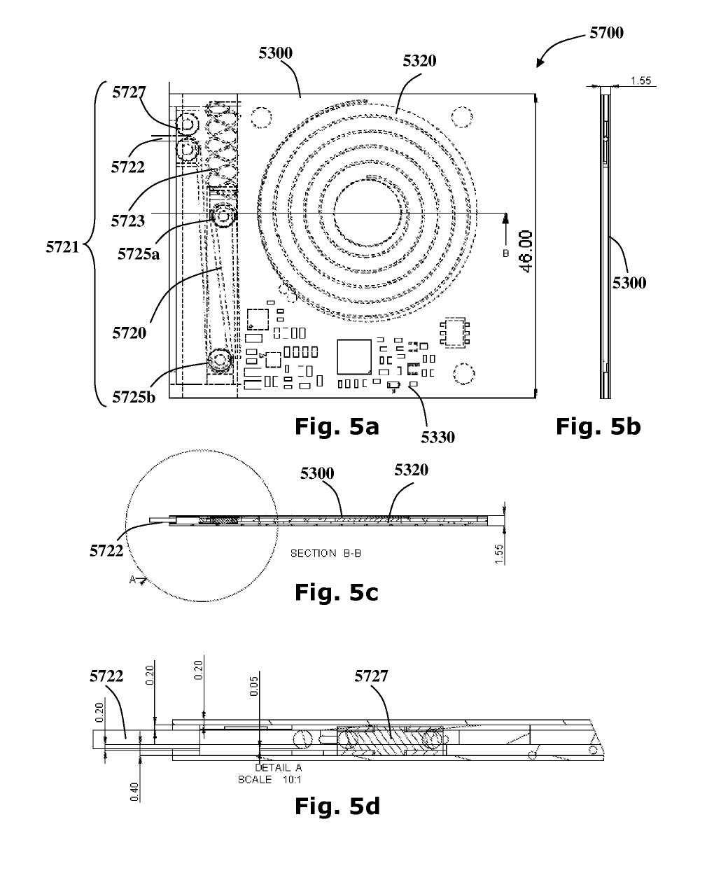

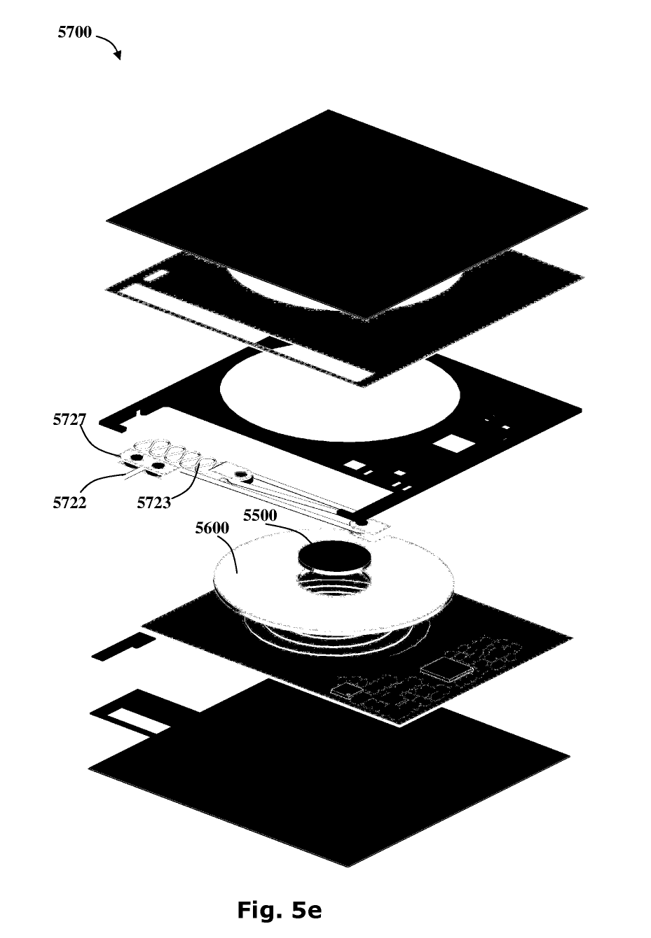

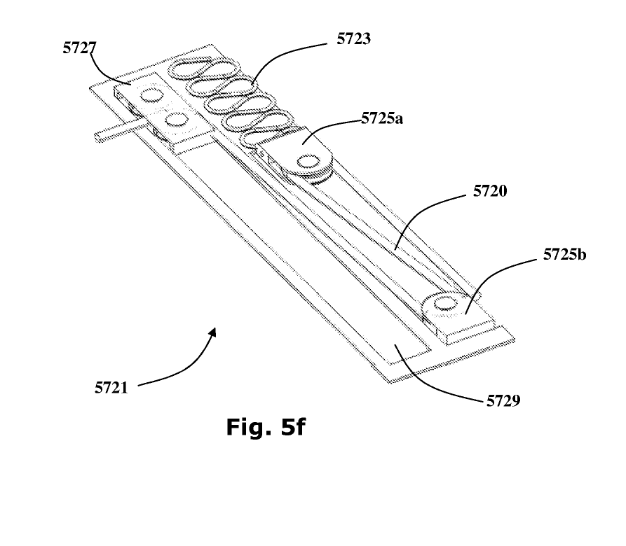

Referring to FIGS. 5a-f, various aspects are shown of still another embodiment of a universal inductive power receiver 5700 of the disclosure. FIG. 5a shows a top view of the inductive power receiver 5700 including a secondary inductor 5320, a receiver circuit 5330, a pin connector 5722 and an extendable connector 5720 and a connector retraction apparatus 5721. FIGS. 5b and 5c show two orthogonal cross sections of the inductive power receiver 5700 and FIG. 5d shows a detailed view of the exit point of the connector from the receiver unit 5300. FIG. 5e shows an exploded isometric view of the inductive power receiver 5700 further illustrating an alignment magnet 5500 and flux guidance shield 5600.

Referring now to the isometric projection of FIG. 5f, a possible embodiment of the connector retraction apparatus 5721 is shown in greater detail. It is a particular feature of the connector retraction apparatus 5721 that it enables a thin wire connector 5700 to be retracted and stowed within the receiver unit 5300. The connector retraction apparatus 5721 includes a retraction spring 5723, a first roller 5725a, a second roller 5725b and a third roller 5727. The connector 5700, which is connected to the receiving circuit 5330, may be threaded through the first roller first roller 5725a, the second roller 5725b and the third roller 5727 and may further extend beyond out of the receiver unit 5300.

The first roller 5725a is coupled to the retraction spring 5723 which acts to urge the first roller back thereby retracting the connector 5720 as far as possible into the receiver unit 5300. The second roller 5725b may fixed to the casing of the receiver unit 5300 and, when at least partially retracted, excess connector length is stowed between the first roller 5725a and the second roller 5725b. It is particularly noted that the third roller 5727 is free to slide along a track 5729 which runs along the side of the receiver unit 5300 such that the extending portion of the connector 5720 may be positioned anywhere along the side of the receiver unit 5300.

It is particularly noted that, although shown here in the context of an inductive power receiver unit 5300, a connector retraction apparatus 5721 may be utilized in a variety of applications where it may be useful to stow a wire connector or to otherwise organize extending wires, strings, threads, yarns or the like. It is further noted that other embodiments of retraction apparatus may be considered such as described herein in relation to FIG. 6b for example.

Referring now to FIGS. 6a-d show a selection of possible embodiments of universal inductive power receivers which having an extendable connector.

FIG. 6a shows another inductive power receiver 6700a including a snake type connector 6720a comprising a plurality of sections and which is retractable into a track 6721 within the casing of the receiving unit 6300a, which may be provided for the purpose.

FIG. 6b shows a further inductive power receiver 6700b including an adjustable type connector 6720b comprising an extractable chord anchored to the receiving unit 6300b via a connector retraction apparatus including two anchor points so that the pin connector 6722b may be positioned as required.

FIGS. 6c and 6d show an isometric projection and an exploded view of a slider type connector 6720c. The slider type connector 6720c includes at least two extended conductive strip contacts 6724c which may be used to connect with corresponding contacts of a receiver unit (not shown). According the slider may be extended from a receiver unit to various distances as required.

With particular reference to the exploded view of FIG. 6d, it will be appreciated that the pin connector 6722c of the embodiment may be configured with either an upward or a downward configuration as suits the power socket of the host electrical device (not shown). Such a plug may be selected from a group including USB connectors, micro USB connectors, mini USB connectors, multipin DC connectors, dock connectors, 30-pin connectors, 8-pin digital connectors, Apple Lightning connectors and the like as well as combinations thereof.

Another embodiment of a reversable plug connector 6722e is scematically represented in FIGS. 6e-g. In FIG. 6e a USB connector plug 6722e is shown connected to a connecting wire 6720e. The connector plug 6722e has an opening 6724e at the point of connection with the connecting wire 6720e such that the connecting wire 6720e may be moved up or down to suit requirments. Accordingly, it is noted that that the same connector plug 6722e may be adjustable into two configurations as shown in FIGS. 6f and 6g. In particular FIG. 6f shows the connector plug 6722e configured such that it is in a ‘SAD’ configuration such that the narrower edge of the connector is uppermost (perhaps resembling a frowning mouth). FIG. 6g shows the same connector plug 6722e alternatively configured such that it is in a ‘HAPPY’ configuration such that the narrower edge of the connector is bottomost (perhaps resembling a smiling mouth). It will be appreciated that embodiments having adjustable or reversable connectors such as those described herein may be conveniently coupled to various electrical devices having power sockets with various orientations.

Referring now to FIGS. 7a-c an embodiment of a universal inductive power receiver 7700 is shown in which various connectors 7720 may be connected to the receiver unit 7300 via a conductive coupler such as a two pin connection point 7340 configured to couple with pin contacts 7724 of the connector 7720. Accordingly, connectors 7720 of various lengths, configurations and plug tips 7722 may be used with a common receiver unit as suit requirements. It is further noted that the receiver unit may be connected to the host device using an adhesive sticker 7310 or the like.

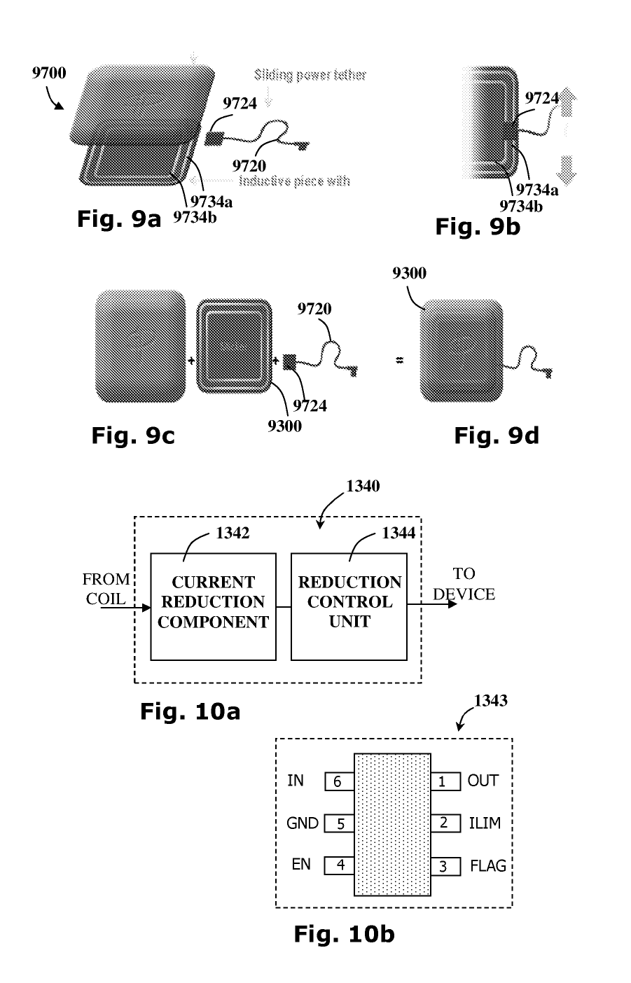

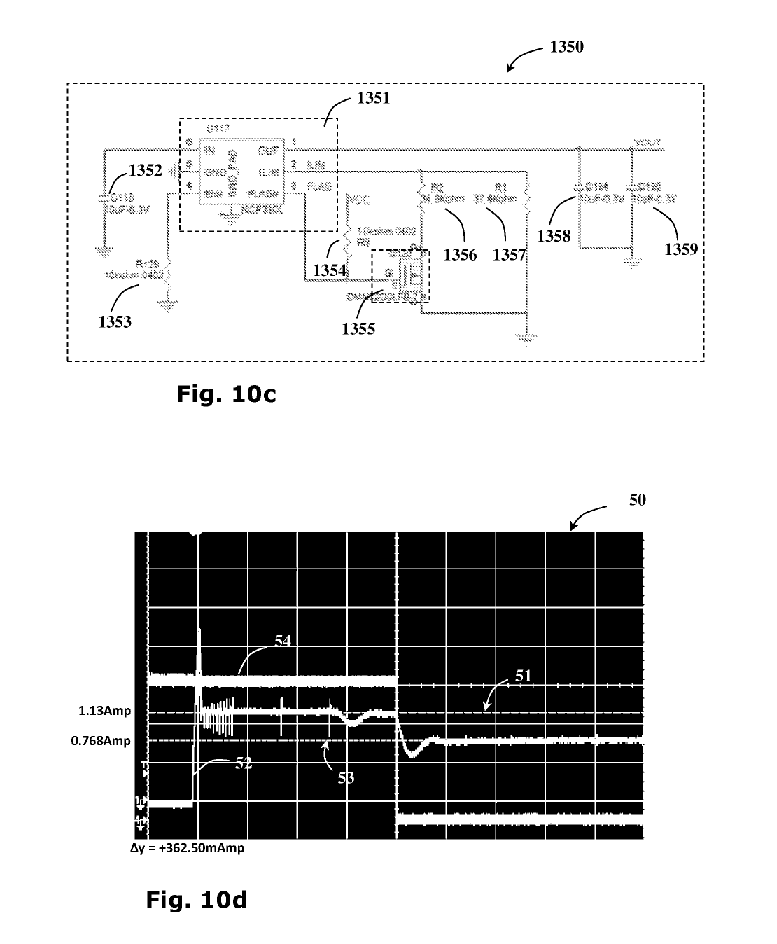

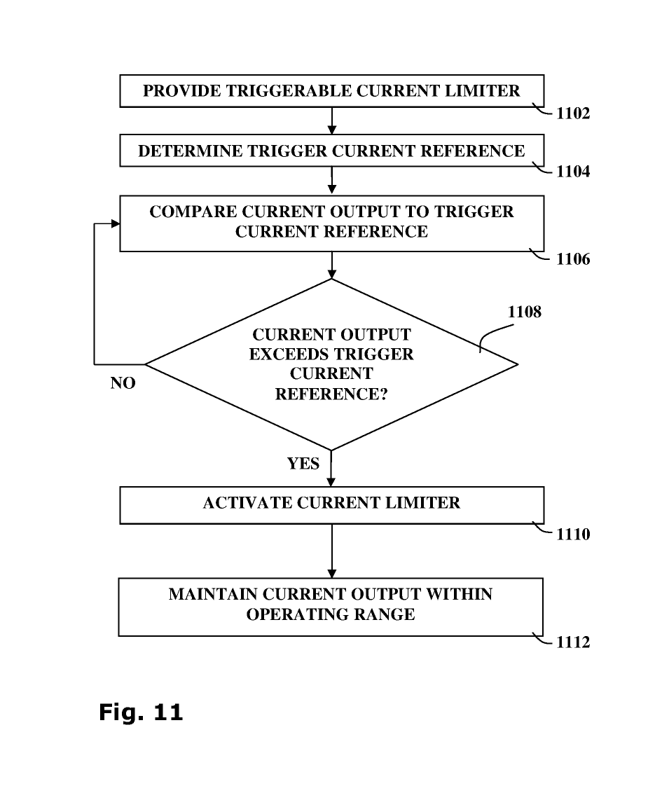

Referring now to FIGS. 8a-c an embodiment of a universal inductive power receiver 8700 is shown in which various connectors 8720 may be connected to the receiver unit 8300 via a conductive coupler such as a multipin connection point 8340 configured to couple with a plurality of contacts 8724 of the connector 8720, for example. Accordingly, connectors 8720 of various lengths, configurations and plug tips 8722 may be used with a common receiver unit as suit requirements. It is further noted that the receiver unit may be connected to the host device using an adhesive sticker 8310 or the like.

Referring now to FIGS. 9a-d an embodiment of a universal inductive power receiver 9700 is shown in which various connectors 9720 may be connected to the receiver unit 9300 via a conductive coupler such as a pair of extended conducting tracks 9734a, 9734b configured to couple with sliding contacts 9724 of the connector 9720, for example. Accordingly, an anode tip may be provided to conductively couple with an anode track 9734a at a plurality of contact points, and a cathode tip may be provided to conductively couple with a cathode track 9734b at a plurality of contact points.

Referring back to FIG. 1c, as described above, in order for the universal inductive power receiver 700 to be compatible with various electrical devices, the power receiving circuit 330 may include a current limiter 340 operable to limit output current where required.

It is noted that the charging process may be temperature dependent. High charging temperatures may damage the electrochemical cell and low temperatures may result in limited charging. Because of this temperature dependency, the power receiving circuit 330 and the current-limiter 340 may be further configured to monitor and regulate the power pack temperature during the charging. Optionally, a temperature sensor, such as a thermistor, thermocouple, digital sensors or the like, may be provided to monitor charging temperature and logic applied to limit charging current in order to keep the temperature within a preferred range. Notably, particular embodiments may be configured to operate within the internal temperature range from say minus ten degrees Celsius to forty-five degrees Celsius (263 Kelvin to 328 Kelvin).

It is noted that while some electrical devices manage their own current consumption, others require current to be limited externally. For example, some electrical devices, such as Apple's iPhone, as well as devices manufactured by Samsung, Nokia, LG, Asus and the like, are configured to operate or charge using currents of up to 1 ampere. Other electrical devices, such as some devices manufactured by BlackBerry, Motorola and the like, may be operable with higher input currents perhaps up to 2 amperes which may bring the device into an unstable state.

The current limiter 340 of the disclosure may be operable to limit the input current for such devices to a predefined level or to a value within a required range. Such current limiting may reduce heat dissipation and instability of the devices. In particular embodiments, a limit of 750 milli-amperes may be provided for charging power cells of electrical devices. It is a particular feature of certain embodiments of the disclosure that the current limiter 340 may be triggerable device configured to be activated when the output current of the power receiver 700 exceeds a trigger current value, for example of about 1.1 amperes or thereabouts.

Accordingly, a universal inductive power receiver may be provided for receiving power inductively from an inductive power outlet and providing a current output to a variety of electric devices each having a characteristic current requirements such as described above. The universal inductive power receiver may include a secondary inductor operable to inductively couple with a primary inductor of an inductive power outlet, and a power receiving circuit comprising a triggerable current limiter operable to maintain said current output within an operating range, say below 750 milli-amperes; and a trigger operable to activate the triggerable current limiter if said current output exceeds a trigger current value, say above 1 ampere.

Reference is now made to FIG. 10a, which is a block diagram representing selected components of a possible automatic current-limiter 1340, for use in a universal wireless charging receiver of the disclosure.

The automatic current-limiter 1340 is configured and operable to manage current and to limit excessive current that may harm an electrical device. The automatic current-limiter 1340 may include various components providing the functionality of automatic current-limiting including a current reduction component 1342 and reduction control component circuitry 1344. The current reduction component 1342, for example an NCP380L component, high-side power distribution switch, having a 6-pin arrangement or the like, may serve to compare output current to the trigger current reference and to trigger the reduction control component 1344.

Variously, the trigger current reference may have a value between 1.0 and 3.0 amperes for example. Particular trigger current values of about 900 milli-amperes, 1.0 amperes, 1.1 amperes, 1.2 amperes, 1.3 amperes, 1.4 amperes, 1.5 amperes, 2.0 amperes, 2.5 amperes, 3.0 amperes may be selected as required. Where appropriate trigger current values below 500 milli-amperes or higher than 3.0 amperes may be selected according to requirements.

Once activated, the reduction control component circuitry 1344 may be configured to enable automatic current control for example limiting current not to exceed a threshold value.

Variously, the current limiter may maintain the output current within a range bounded by an upper value of between 100 milli-amperes and 3.0 amperes for example, particular upper bound values of about 600 milli-amperes, 700 milli-amperes 750 milli-amperes 800 milli-amperes, 900 milli-amperes, 1.0 amperes, 1.1 amperes, 1.2 amperes, 1.3 amperes, 1.4 amperes, 1.5 amperes, 2.0 amperes, 2.5 amperes, 3.0 amperes may be selected as required. Where appropriate values below 500 milli-amperes or higher than 3.0 amperes may be selected according to requirements.

If output load exceeds the trigger current reference value, then the output current may be reduced, for example to 750 milli-amperes or so, and maintained at a steady state, thereafter.

Reference is now made to the block diagram of FIG. 10b representing a possible configuration of an example switch component 1343, as may be used in the automatic current-limiter 1340.

The switch component 1343 may be a high side power-distribution switch for limiting the output current. Current-limiting may be used in applications such as laptop computers, tablet computers, desktop computers, hubs, set top boxes, televisions, gaming products or the like. The NCP380L component, for example, may limit output current to a desired level by switching into a constant-current mode when the output load exceeds the current-limit threshold or a short circuit is detected. It is noted that although the NCP380L is described here for illustrative purposes, other current reduction components may be used as will occur to those skilled in the art.

Variously, the current-limit threshold may be internally determined or may be user adjustable in ranges between 100 milli-amperes and 1.5 amperes or the like, via an external resistor. An internal reverse-voltage detection comparator may disable the power switch if the output voltage is higher than the input voltage to protect devices on the input side of the switch. The power switch rise and fall times are controlled to minimize current ringing during switching.

Optionally, the switch component includes 6-pin arrangement. The OUT pin is of Output type for power-switch output voltage; the ILIM pin may be of Input type serving as an external resistor to set current-limit threshold with a possible resitance range of between 5 kilo-ohms and 250 kilo-ohms; the FLAG pin may be of Output type, used as a reduction indicator, controlling the switch by a logic enable input active high or low; the EN pin may be of Input type to enable or disable input; GND may be of Power type used as a ground connection; and IN may be of Input type for the power switch input voltage. Other switch components with other configurations may be selected as suit requirements.

Reference is now made to the circuit diagram of FIG. 10c representing a possible circutry design 1350 of elements supporting an automatic current-limiting functionality that may be used as part of a universal wireless charging receiver.

Supporting a universal wireless charging receiver as part of a wireless power charging system may require control, regulation or limiting of the current for different electrical devices.

Some electrical devices, when operating without a current limiter, may draw current that may reach a higher level up to 2 ampers and with a voltage level of around 3.7 volts, say, and may bring the device system into an unstable state. In order to reduce heat dissipation and to protect circuitry, such devices may depend on the external charging mechanism to limit the current level to roughly 750 milli-amperes.

It is a particular feature of the universal wireless charging receiver to provide current-limiting circuitry with the ability to control current levels required, automatically, as described hereinabove. The current-limiter may enable current of 1 ampere while charging, but may reduce the current to a limited current, say 750 milli-amperes or the like, if a predefined trigger threshold is exceeded.

The current-limit reduction unit circuitry 1350 may include a current limiting high side power-distribution switch component 1351, an N-CHANNEL enhancement mode MOSFET DMN62D0LFB component 1355, a filtering capacitor of 10 microfarads for 6.3 volts 1352 connected to the IN pin of the power-distribution switch 1343, a resistor of 10 kilo-ohm 1353 connected to EN pin of the power-distribution switch 1343, a resistor of 10 kilo-ohm 1354 connected to the line between the FLAG pin and the N-CHANNEL enhancement mode MOSFET component 1355, two resistors of 34.8 kilo-ohm component 1356 of 37.4 kilo-ohm component 1357 connected in parallel and to the line between the ILIM pin of power-distribution switch 1351 and the N-CHANNEL enhancement mode MOSFET component 1355. Additionally, the current-limit reduction unit circuitry 1350 may include two capacitors 1358 and 1358 each of 10 microfarads for 6.3 volts connected in parallel to the OUT pin of the power-distribution switch 410.

Accordingly the device limits the output current to a desired level by switching into a constant-current regulation mode when the output load exceeds the current-limit threshold, the trigger current reference, or a short circuit is detected. The FLAG logic output may function as an activation signal for the automatic triggerable current limiter. Accordingly, the FLAG signal may assert low during over current, reverse-voltage or over temperature conditions. The switch is controlled by a logic enable input active high or low.

The FLAG is set to low when the current exceeds a trigger current threshold value, switching its value according to the resistor components 1356 and 1357, causing the current to reach a current value of 1.3 amperes, say, and to be drained to reduce to a current level of 750 milli-amperes. The FLAG pin is set to low, reducing the resistance thus, being drained by the resistors that determine the current level.

Additionally, in order to avoid current fluctuations (ringing) that may cause the power-distribution switch 1343 ringing effect, the power-distribution switch 1343 may be configured to delay, thus keeping a constant current of 750 milli-amperes.

It is noted that the universal wireless charging receiver circuit may be connected to the IN pin of the power-distribution switch 1343 and that the OUT pin of current-limit reduction unit circuitry 1340 is connected to the mobile phone device.

It is further noted that the current in the OUT pin of the current-limit reduction unit circuitry 1350 may depend upon and be controlled by the ILIM pin, while the EN pin may control or enables shut down. The shutdown pin provides external control for enabling and disabling the MOSFETs as well as placing the device in a low current shutdown state.

Reference is now made to the graphical illustration 50 of FIG. 10d representing a possible output display of the circutry design elements supporting the automatic current-limit reduction unit 1340.

The graphical illustration 50 of output display of the automatic current-limit reduction unit circuitry 1350 may include an X-Y coordinate's display, dotted line of threshold level 51, dotted line of operable reduced current level 53, graphic display of actual operable current level 52, and FLAG pin graphical control behavior display 54.

The current-limit value may be configured through the resistor in the ILIM pin, having the current-limit set to 1.1 amperes, while the FLAG pin signal will indicate the component is limiting the current, by changing the resistance of the ILIM pin accordingly.

The current fluctuates according to the current drawn by the device, and if it exceeds the threshold value of 1.1 amperes the FLAG pin will signal accordingly to change the resistance and reduce the current towards 750 milli-amperes or so.

The graphical illustration 50 of the output display shows the current exceeding the current-limit threshold or current trigger reference, reaching a value of 1.13 amperes, causing the FLAG to drop down from high active to low active as represented by the graphical line denoted as 54, thereby producing an activation or trigger signal. In consequence, the current-limiter is activated and a signal is sent to the ILIM pin. The reduction of current is represented by the graphical line 52, where the current is reduced by 0.362 ampere, from 1.13 ampere to 0.768 ampere.

It is noted that the FLAG logic output may assert high during a period of over current, such as noted by the graphical line 54, and the output display is reflected by the graphical line 54, indicating a sharp fall of active low.

Reference is now made to the flowchart of FIG. 11 representing selected actions of a method for controlling output current from a universal wireless power receiver of the disclosure. The method comprises: providing a triggerable current limiter 1102; determining a trigger current reference 1104; and comparing the current output to the trigger current reference 1106. If current output exceeds the trigger current reference 1108 then activating the current limiter 1110; and maintaining said current output within an operating range 1112.

Technical and scientific terms used herein should have the same meaning as commonly understood by one of ordinary skill in the art to which the disclosure pertains. Nevertheless, it is expected that during the life of a patent maturing from this application many relevant systems and methods will be developed. Accordingly, the scope of the terms such as computing unit, network, display, memory, server and the like are intended to include all such new technologies a priori.

As used herein the term “about” refers to at least ±10%.

The terms “comprises”, “comprising”, “includes”, “including”, “having” and their conjugates mean “including but not limited to” and indicate that the components listed are included, but not generally to the exclusion of other components. Such terms encompass the terms “consisting of” and “consisting essentially of”.

The phrase “consisting essentially of” means that the composition or method may include additional ingredients and/or steps, but only if the additional ingredients and/or steps do not materially alter the basic and novel characteristics of the claimed composition or method.

As used herein, the singular form “a”, “an” and “the” may include plural references unless the context clearly dictates otherwise. For example, the term “a compound” or “at least one compound” may include a plurality of compounds, including mixtures thereof.

The word “exemplary” is used herein to mean “serving as an example, instance or illustration”. Any embodiment described as “exemplary” is not necessarily to be construed as preferred or advantageous over other embodiments or to exclude the incorporation of features from other embodiments.

The word “optionally” is used herein to mean “is provided in some embodiments and not provided in other embodiments”. Any particular embodiment of the disclosure may include a plurality of “optional” features unless such features conflict.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween. It should be understood, therefore, that the description in range format is merely for convenience and brevity and should not be construed as an inflexible limitation on the scope of the disclosure. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6 as well as non-integral intermediate values. This applies regardless of the breadth of the range.

It is appreciated that certain features of the disclosure, which are, for clarity, described in the context of separate embodiments, may also be provided in combination in a single embodiment. Conversely, various features of the disclosure, which are, for brevity, described in the context of a single embodiment, may also be provided separately or in any suitable subcombination or as suitable in any other described embodiment of the disclosure. Certain features described in the context of various embodiments are not to be considered essential features of those embodiments, unless the embodiment is inoperative without those elements.

Although the disclosure has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present disclosure. To the extent that section headings are used, they should not be construed as necessarily limiting.

The scope of the disclosed subject matter is defined by the appended claims and includes both combinations and sub combinations of the various features described hereinabove as well as variations and modifications thereof, which would occur to persons skilled in the art upon reading the foregoing description.

1. A method for controlling output current to an electric device from a secondary coil of a wireless power receiver, the method comprising:
providing a triggerable current limiter having an input wired to said wireless power receiver and an output connected to said electric device;
determining a trigger current reference;
comparing said current output to said trigger current reference;
if said current output exceeds said trigger current value then activating said current limiter; and
when activated, said current limiter maintaining said current output within an operating range.

2. The method of claim 1 wherein said trigger current value is about one ampere.

3. The method of claim 1 wherein said operating range is characterized by an upper current limit value.

4. The method of claim 1 wherein said upper current limit value is 750 milli-amperes.

5. A wireless power receiver for receiving power inductively from wireless power outlet and providing a current output to an electric device, the wireless power receiver comprising a secondary inductor operable to receive power from a primary inductor of a wireless power outlet, and a power receiving circuit for controlling power relayed to said electric device;
wherein said power receiving circuit comprises:
a triggerable current limiter having an input wired to said wireless power receiver and an output connected to said electric device, said triggerable current limiter operable to maintain said current output within an operating range; and
a trigger operable to activate said triggerable current limiter if said current output exceeds a trigger current reference.

6. The universal inductive power receiver of claim 5 wherein said triggerable current limiter comprises a high side power-distribution switch.

7. An inductive power receiver for receiving power inductively from an inductive power outlet and relaying power to an electric device, the inductive power receiver further comprising:
a receiver unit comprising a secondary inductor operable to inductively couple with a primary inductor of an inductive power outlet, and a power receiving circuit for controlling power relayed to said electric device; and
a connector for conductively coupling said inductive receiving circuit to said electric device via a power socket;
wherein said inductive power receiver is affixable to said electric device in a plurality of configurations such that the position of the connector is adaptable to suit a plurality of power socket locations.

8. The power receiver of claim 7 wherein said connector is configured to extend from said receiving unit with a plurality of extensions.

9. The power receiver of claim 7 wherein said connector comprises a stretchable flex.

10. The power receiver of claim 9 wherein said stretchable flex comprises at least two conductive lines embedded in an elastic material.

11. The power receiver of claim 9 wherein said stretchable flex comprises at least two conductive lines having an extendable configuration such that when said stretchable flex is extended the conductive lines remain unbroken.

12. The power receiver of claim 11 wherein said extendable configuration is selected from at least one of a group consisting of: coiled configurations, zig-zag configurations, helical configurations, telescopic configurations or combinations thereof.

13-18. (canceled)

19. The power receiver of claim 7 wherein said receiver unit comprises at least one conducting track and said connector comprises at least one conducting tip configured to selectably conductively couple with said conducting track at a plurality of points.

20. The power receiver of claim 7 wherein said receiver unit comprises an anode track and a cathode track and said connector comprises:
an anode tip configured to conductively couple with said anode track, and
a cathode tip configured to conductively couple with said cathode track.

21. The power receiver of claim 7 wherein said connector is configured to connect said receiver unit to said electric device over a plurality of distances.

22. The power receiver of claim 7 wherein said receiver unit comprises an upper cover and a lower cover configured to snap connect thereby securing said connector therebetween in conductive communication with said receiver circuit.

23. The power receiver of claim 7 wherein said connector comprises a plug tip configured to couple with the power socket with the power socket of the electric device.

24. The power receiver of claim 23 wherein said plug tip is adaptable to fit a plurality of configurations of said power socket.

25. The power receiver of claim 23 wherein said plug tip is selected from a group consisting of: USB connectors, micro USB connectors, mini USB connectors, multipin DC connectors, dock connectors, 30-pin connectors, 8-pin digital connectors, Apple Lightning connectors and combinations thereof.

26. The power receiver of claim 7 further comprising an adhesive layer for affixing said receiver unit to said electrical device.
